(19) United States
(12) Patent Application Publication
(10) Pub. No.: US 2026/0039060 A1
(43) Pub. Date: Feb. 5, 2026

(54) FLOATING TERMINAL, RECEPTACLE CONNECTOR AND PLUG CONNECTOR

(71) Applicant: Molex, LLC, Lisle, IL (US)

(72) Inventors: Xue-Hai Zhang, Shanghai (CN); Shuai Mi, Shanghai (CN)

(21) Appl. No.: 19/290,416

(22) Filed: Aug. 5, 2025

(30) Foreign Application Priority Data
Aug. 5, 2024 (CN) 202411067408.0
Jun. 10, 2025 (CN) 202510772401.7

(51) Int. Cl. H01R 13/631

(52) U.S. Cl. CPC H01R 13/6315

(57) ABSTRACT

A floating terminal, a receptacle connector and a plug connector are provided. The floating terminal includes: a base portion; a fixing portion connected with a first side of the base portion; a contacting portion comprising a first sub-contact portion and a second sub-contact portion which are spaced apart from each other and face each other, the first sub-contact portion and the second sub-contact portion are connected via a connecting portion; an elastic arm bending from at least a part of a second side of the base portion toward a direction which is close to the contacting portion and extending, and then being connected to the first sub-contact portion, the second side and the first side of the base portion being adjacent to each other. The floating terminal helps promote stability of electrical connection and contact performance between the electrical connectors and adaptability of the receptacle connector in different application situations.

### TECHNICAL FIELD

The present disclosure relates to the technical field of electrical connectors, and specifically relates to a floating terminal, a receptacle connector and a plug connector.

### BACKGROUND

An electrical connector is a device used for bridging between different electronic devices and ensuring accurate signal transmission, is widely applied to fields, such as computer interfaces, communications, domestic appliances and the like, at present, and is a structure which cannot be lacked in circuits of the electronic devices to realize preset function.

Electrical connectors generally include a male connector and a female connector which mate with each other. The male connector and the female connector respectively use a male terminal and a female terminal to realize signal transmission. However, in a process that the electrical connector is fitted to each electronic product, there may be fitting error, which affects stability of electrical connection between the male terminal and the female terminal of the electrical connectors.

It should be noted that the information disclosed in the background is only for enhancing the understanding of the background of the present disclosure, and therefore may include information that does not constitute the prior art known to those of ordinary skill in the art.

### SUMMARY

In view of the above, the present disclosure provides a floating terminal, a receptacle connector and a plug connector, which can promote stability of electrical connection and contact performance between the electrical connectors and enhance adaptability of the receptacle connector in different application situations.

According to some embodiments, an aspect of the present disclosure provides a floating terminal comprising: a base portion; a fixing portion connected with a first side of the base portion; a contacting portion comprising a first sub-contact portion and a second sub-contact portion which are spaced apart from each other and face each other, the first sub-contact portion and the second sub-contact portion are connected via a connecting portion; an elastic arm bending from at least a part of a second side of the base portion toward a direction which is close to the contacting portion and extending, and then being connected to the first sub-contact portion, the second side and the first side of the base portion being adjacent to each other.

In some embodiments, an elastic force of the second sub-contact portion is larger than an elastic force of the elastic arm.

In some embodiments, the elastic arm is connected to the first sub-contact portion via a bending portion, an end of the bending portion which is connected to the first sub-contact portion bends toward the second sub-contact portion relative to an end of the bending portion which is connected to the elastic arm.

In some embodiments, at least one side of the base portion is provided with a bending segment, the bending segment bends downwardly toward a direction which is away from the contacting portion.

In some embodiments, the base portion further comprises a third side opposite to the first side, at least one side of the first side and the third side of the base portion is sequentially provided with the bending segment and a horizontal segment.

In some embodiments, the first side of the base portion is sequentially provided with a first bending segment and a first horizontal segment; the fixing portion is connected to a side of the first horizontal segment, which is away from the first bending segment, to be connected to the first side of the base portion; the third side of the base portion is sequentially provided with a second bending segment and a second horizontal segment.

In some embodiments, the horizontal segment provided to the third side of the base portion extends along a direction which is away from the first side of the base portion, or extends along a direction which is toward the first side of the base portion.

In some embodiments, the base portion further comprises a fourth side opposite to the second side, the fourth side of the base portion is provided with the bending segment and a vertical segment.

In some embodiments, two sides of the fixing portion are provided with at least one pair of protruding portions.

According to some embodiments, the present disclosure further provides another floating terminal comprising: a base portion having a first side which is provided with a bending segment and a horizontal segment; a contacting portion comprising a first sub-contact portion and a second sub-contact portion which are spaced apart from each other and face each other, the first sub-contact portion and the second sub-contact portion are connected via a connecting portion; an elastic arm bending from at least a part of a second side of the base portion toward a direction which is close to the contacting portion and extending, and then being connected to the first sub-contact portion, the second side and the first side of the base portion are adjacent to each other.

In some embodiments, two sides of the base portion are provided with at least one pair of protruding portions, the two protruding portions in the pair of protruding portions are respectively provided to the second side and a third side of the base portion, the third side of the base portion is opposite to the second side.

The above floating terminal comprises the base portion, the fixing portion, the contacting portion and the elastic arm, wherein the elastic arm provides an elastic force which makes the contacting portion generate floating and displacing. As such, an offset due to vibration, fitting error or other errors in a fitting process is effectively compensated, and stability of electrical connection between the floating terminal and the plug terminal is ensured.

In the above floating terminal, the contacting portion comprises the first sub-contact portion and the second sub-contact portion, the first sub-contact portion and the second sub-contact portion are connected with each other via the connecting portion, the first sub-contact portion and the second sub-contact portion are respectively provided with a first contact point and a second contact point. By provision of the two contact points, a contacting area between the floating terminal and the plug terminal is increased, so that reliability and stability of signal transmission is enhanced. In conjunction with the elastic arm, the contacting portion can be adaptively adjusted, which may ensure that the floating terminal and the plug terminal always maintain good contact state therebetween.

The design of the elastic arm in the floating terminal makes the contacting portion can freely float in a certain range, to be adapted to tolerance variation in a fitting process in different application situations. Therefore, with the embodiments of the present disclosure, working reliability of the receptacle connector in various complex circumstances can be further promoted, to make the receptacle connector perform excellently in different application situations.

According to some embodiments, the present disclosure further provides another floating terminal comprising: a contacting portion comprising a first sub-contact portion and a second sub-contact portion which are spaced apart from each other and face each other, the first sub-contact portion and the second sub-contact portion are connected via a first connecting portion; a fixing portion comprising a first sub-fixing portion and a second sub-fixing portion which are spaced apart from each other and face each other, the second sub-fixing portion and the first sub-fixing portion are connected via a second connecting portion; an elastic arm extending obliquely from the first sub-contact portion toward a direction which is close to the fixing portion and then being connected to the first sub-fixing portion.

In some embodiments, the first sub-contact portion and the first sub-fixing portion are parallel to each other, and the second sub-contact portion and the second sub-fixing portion are parallel to each other.

In some embodiments, a width of a connected location between the elastic arm and the first sub-contact portion is less than a width of a connected location between the elastic arm and the first sub-fixing portion.

In some embodiments, a distance between the contacting portion and the fixing portion is larger than the width of the connected location between the elastic arm and the first sub-fixing portion.

The floating terminal also may make it so that the contacting portion is capable of freely floating in a certain range by means of the elastic arm, to be adapted to tolerance variation in a fitting process in different application situations. Moreover, the floating terminal can lengthen an elastic length of the elastic arm in a horizontal direction in a limited space, in a precondition that an entire dimension of the floating terminal is not increased, an elastic force of the elastic arm is reduced, which makes the floating terminal more adapted to small space application situations. Lengthening the elastic length of the elastic arm in the horizontal direction is helpful to ensure that the floating terminal still can realize reliable electrical contact in a narrow and small space, so that connecting reliability and fitting fault tolerance of the floating terminal in small space application situations is promoted.

According to some embodiments, another aspect of the present disclosure further provides a receptacle connector comprising at least one floating terminal of at least one aforementioned embodiment and a receptacle housing; the receptacle housing is provided with at least one terminal receiving cavity and at least one terminal fixing groove, the terminal receiving cavity corresponds to the terminal fixing groove in one-to-one; wherein, the terminal fixing groove is used to fix the floating terminal, the terminal receiving cavity is used to receive the contacting portion and the elastic arm of the floating terminal in a manner that the contacting portion of the floating terminal is capable of floating in the terminal receiving cavity, the base portion of the floating terminal is at least partially exposed from a bottom of the receptacle housing.

In some embodiments, a cavity opening of the terminal receiving cavity comprises a first opening which is provided to a first surface of the receptacle housing and a second opening which is provided to a second surface of the receptacle housing, the first surface and the second surface are adjacent to each other, and the first opening and the second opening are communicated with each other.

In some embodiments, the cavity opening of the terminal receiving cavity is provided with a housing guide surface, the housing guide surface is connected with an inner wall of the terminal receiving cavity, and is oblique outwardly relative to the inner wall of the terminal receiving cavity.

In some embodiments, the receptacle housing is further provided with at least one foolproof receiving cavity, the foolproof receiving cavity is provided alongside one terminal receiving cavity.

According to some embodiments, another aspect of the present disclosure further provides a receptacle connector comprising at least one floating terminal of at least one aforementioned embodiment and a receptacle housing, the receptacle housing is provided with at least one terminal receiving cavity and at least one pair of terminal fixing grooves, each terminal receiving cavity corresponds to one pair of terminal fixing grooves; wherein, the terminal fixing groove is used to fix the floating terminal, the terminal receiving cavity is used to receive the contacting portion and the elastic arm of the floating terminal in a manner that the contacting portion of the floating terminal is capable of floating in the terminal receiving cavity.

In some embodiments, a cavity opening of the terminal receiving cavity comprises a first opening which is provided to a first surface of the receptacle housing, a second opening which is provided to a second surface of the receptacle housing, and a third opening which is provided to a third surface of the receptacle housing; the third surface, the first surface and the second surface are sequentially connected to each other, and the third opening, the first opening and the second opening are sequentially communicated with each other.

According to some embodiments, still another aspect of the present disclosure further provides a plug connector used to correspondingly mate with the receptacle connector of the aforementioned embodiment, the plug connector comprises at least one plug terminal, wherein, the plug terminal of the plug connector mates with the floating terminal of the corresponding receptacle connector, to realize electrical connection between the plug connector and the receptacle connector.

In some embodiments, the plug connector further comprises at least one plug housing; the plug terminal comprises a mounting region and a contacting region, the mounting region inserts into the plug housing, the contacting region extends out of the plug housing.

In some embodiments, the mounting region of the plug terminal inserts into the plug housing along a first direction; a width of the contacting region of the plug terminal in a second direction is larger than a width of the mounting region in the second direction; the second direction is perpendicular to the first direction.

In some embodiments, the receptacle housing is further provided with at least one foolproof receiving cavity, the foolproof receiving cavity is provided alongside one terminal receiving cavity; the plug housing is provided with at least one foolproof structure, the foolproof structure is configured so that the foolproof structure is positioned alongside one plug terminal when the plug housing sheathes the plug terminal, the foolproof structure is used to insert into the foolproof receiving cavity of the corresponding receptacle connector.

The other advantages, objects and features of the present disclosure will be described in the subsequent description to some extent, and will be apparent to those skilled in the art to some extent based on the investigation and research of the following content, or can be taught from the practice of the present disclosure. The objects and other advantages of the present disclosure can be realized and obtained through the following description.

### BRIEF DESCRIPTION OF THE DRAWINGS

Other features, objects, and advantages of the present disclosure will become more apparent by reading the detailed description of non-limiting embodiments with reference to the accompanying drawings.

FIGS. 1A-1E illustrate views of a first embodiment of a floating terminal provided by the present disclosure, where FIG. 1A is a perspective view, FIG. 1B is a perspective view viewed from another angle, FIG. 1C is a rear view; FIG. 1D is a front view, and FIG. 1E is a right view;

FIGS. 2A-2C illustrate schematic views that the floating terminal provided by some embodiments and a plug terminal mate with each other, where FIG. 2A illustrates that there is not offset between the floating terminal and the plug terminal, FIG. 2B illustrates that the plug terminal is offset toward a side which is connected with an elastic arm, and FIG. 2C illustrates that the plug terminal is offset toward a side which is not connected with the elastic arm;

FIGS. 3A and 3B illustrate views of a second embodiment of the floating terminal provided by the present disclosure, where FIG. 3A is a perspective view, and FIG. 3B is a front view;

FIGS. 4A and 4B illustrate views of a third embodiment of the floating terminal provided by the present disclosure, where FIG. 4A is a perspective view, and FIG. 4B is a front view;

FIGS. 5A and 5B illustrate views of a fourth embodiment of the floating terminal provided by the present disclosure, where FIG. 5A is a perspective view, and FIG. 5B is a front view;

FIG. 6 is a perspective view of a fifth embodiment of the floating terminal provided by the present disclosure;

FIG. 7 is a front view of the floating terminal of FIG. 6;

FIG. 8 is a perspective view of the floating terminal of FIG. 6 viewed from another angle;

FIG. 9 is a view that the front view of FIG. 7 is rotated anticlockwise by 90 degrees;

FIG. 10 is a side view of the floating terminal of FIG. 6;

FIG. 11 is a perspective view of a receptacle connector in some embodiments of the present disclosure;

FIGS. 12A and 12B illustrate views of the receptacle connector of FIG. 11, where FIG. 12A is a top view, and FIG. 12B is a cross-sectional view taken along a line F-F of FIG. 12A;

FIG. 13 is a perspective exploded view of the receptacle connector of FIG. 11;

FIG. 14 is a perspective exploded view of the receptacle connector of FIG. 11 viewed from another angle;

FIG. 15 is a perspective view illustrating that the floating terminal of FIGS. 3A and 3B is mounted to a receptacle housing;

FIG. 16 is a front view illustrating that the receptacle connector of FIG. 15 is provided to a PCB;

FIG. 17 is a perspective view illustrating that the floating terminal of FIGS. 4A and 4B is mounted to the receptacle housing;

FIG. 18 is a front view illustrating that the receptacle connector of FIG. 17 is provided to a PCB;

FIG. 19 is a perspective exploded view illustrating that the floating terminal of FIGS. 5A and 5B is mounted to the receptacle housing;

FIG. 20 is a perspective exploded view of the receptacle connector of FIG. 19 viewed from another angle;

FIG. 21 is a front view illustrating that the receptacle connector of FIG. 19 is provided to a PCB;

FIG. 22 is a perspective view of the receptacle connector of FIG. 19;

FIGS. 23A and 23B illustrate views of the receptacle connector, where FIG. 23A is a top view of FIG. 19, and FIG. 23B is a cross-sectional view taken along a line A-A of FIG. 23A;

FIGS. 24A and 24B illustrate views of the receptacle connector, where FIG. 24A is a left view of FIG. 19, and FIG. 24B is a cross-sectional view taken along a line E-E of FIG. 24A;

FIG. 25 is a perspective view of a receptacle connector in other embodiments of the present disclosure;

FIG. 26 is a rear view of the receptacle connector of FIG. 25;

FIG. 27 is a perspective view of the receptacle connector of FIG. 25 viewed from another angle;

FIG. 28 is a perspective view of a receptacle housing of the receptacle connector of FIG. 25;

FIG. 29 is a rear view of the receptacle housing of FIG. 28;

FIG. 30 is a perspective exploded view of the receptacle connector of FIG. 25;

FIG. 31 is a perspective exploded view of the receptacle connector of FIG. 25 viewed from another angle;

FIG. 32 is a perspective view illustrating that the receptacle connector of FIG. 25 is provided to a PCB;

FIG. 33 is a perspective view illustrating that the receptacle connector of FIG. 25 is provided to the PCB and viewed from another angle;

FIG. 34 is a perspective view illustrating that a first embodiment of a plug connector and the receptacle connector provided by the present disclosure mate with each other;

FIG. 35 is a front view illustrating that a second embodiment of the plug connector and the receptacle connector mate with each other;

FIG. 36 is a front view a perspective exploded view of the second embodiment of the plug connector provided by the present disclosure;

FIG. 37 is a perspective exploded view of the plug connector of FIG. 36 viewed from another angle;

FIG. 38 is a perspective view of the second embodiment of the plug connector provided by the present disclosure;

FIGS. 39A and 39B illustrate views of the second embodiment of the plug connector provided by the present disclosure, where FIG. 39A is a front view, and FIG. 39B is a cross-sectional view taken along a line B-B of FIG. 39A; and

FIG. 40 is a perspective view that the plug connector of FIG. 38 is covered with an adhesive layer.

### DETAILED DESCRIPTION

In order to facilitate understanding of the present disclosure, the present disclosure will be more comprehensively described below with reference to the relevant drawings. Preferred embodiments of the present disclosure are shown in the drawings. However, the present disclosure can be implemented in many different forms and is not limited to the embodiments described herein. On the contrary, a purpose of providing these embodiments is to make the disclosed content of the present disclosure more thorough and comprehensive.

Unless otherwise defined, all technical and scientific terms used herein have the same meanings as those commonly understood by those skilled in the art belonging to the present disclosure. The terms used in the specification of the present disclosure are only for the purpose of describing specific embodiments and are not intended to limit the present disclosure.

It may be understood that, although the terms “first,” “second” and the like may be used to describe various elements, these elements should not be limited by these terms. These terms are only used to distinguish a first element from another element. For example, without departing from the scope of the present disclosure, a first sub-contact portion may be referred to as a second sub-contact portion, and similarly, the second sub-contact portion may be referred to as the first sub-contact portion. The first sub-contact portion and the second sub-contact portion both are sub-contact portions, but are not the same sub-contact portion.

It may be understood that, in the following embodiments, “connection” should be understood as “electrical connection,” “communication connection” or the like, if the connected circuits, modules, units, and the like have transmission of electrical signals or data therebetween.

When used herein, singular forms of “a/an,” “o,””, and “the” may also include plural forms, unless the context clearly indicates other forms. It should further be understood that, when the terms “include/comprise” and/or “have” determine the presence of the described feature, entirety, assembly, part, or a combination thereof, but possibility of the presence or addition of one or more other feature, entirety, assembly, part, or a combination thereof is not excluded. Meanwhile, when used herein, the term “and/or” includes any and all combinations of the listed items.

Electrical connectors generally include a male connector and a female connector which mate with each other. The male connector and the female connector respectively use a male terminal and a female terminal to realize signal transmission. However, in a process that the electrical connector is fitted to each electronic product, there may be fitting error, which affects stability of electrical connection between the male terminal and the female terminal of the electrical connectors.

In view of the above, the present disclosure provides a floating terminal, a receptacle connector and a plug connector which can promote stability of electrical connection and contact performance between the electrical connectors and enhance adaptability of the receptacle connector in different application situations. A detailed content will be described in the subsequent embodiments.

According to some embodiments, the present disclosure provides a floating terminal. It is noted that, the floating terminal also may be referred to as the “female terminal.”

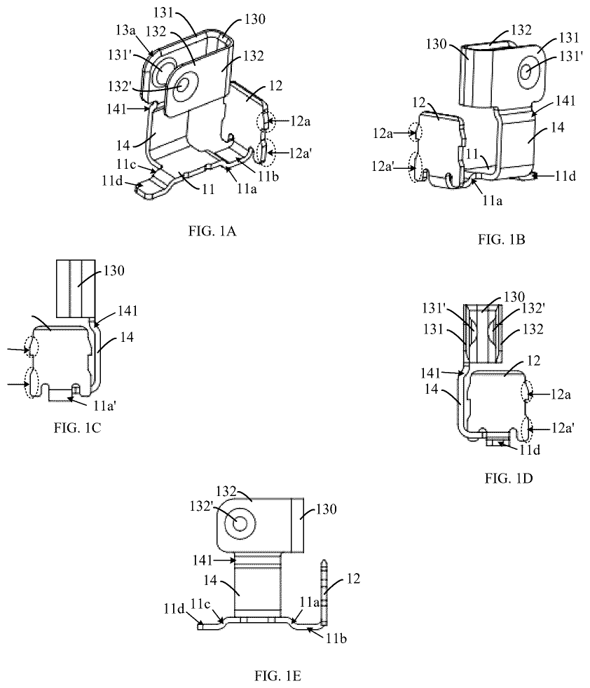

Referring to FIGS. 1A-1E, the floating terminal specifically may include a base portion 11, a fixing portion 12, a contacting portion and an elastic arm 14.

Wherein, the fixing portion 12 is connected with a first side of the base portion 11. The contacting portion specifically may include a first sub-contact portion 131 and a second sub-contact portion 132 which are spaced apart from each other and face each other, the first sub-contact portion 131 and the second sub-contact portion 132 are connected with each other via a connecting portion 130, to form one or more openings. The first sub-contact portion 131 is provided with a first contact point 131′, and the second sub-contact portion 132 is provided with a second contact point 132′. The elastic arm 14 bends from at least a part of a second side of the base portion 11 toward a direction which is close to the contacting portion and extends, and then is connected to the first sub-contact portion 131.

It is noted that, in the present embodiment, the second side and the first side of the base portion 11 are adjacent to each other.

With the floating terminal mating with a plug terminal, when there is offset between a center of the floating terminal and a center of the plug terminal, for example, connector fitting error, application end fitting error or other error and the like, the elastic arm 14 can float in a left-right direction to maintain reliable and good electrical connection between the contacting portion and the plug terminal.

In the floating terminal, the contacting portion includes the first sub-contact portion 131 and the second sub-contact portion 132 which are connected to each other via the connecting portion 130. Optionally, the first sub-contact portion 131 and the second sub-contact portion 132 may be respectively provided with the first contact point 131′ and the second contact point 132′. By provision of the two contact points, the floating terminal and the plug terminal may have stable contact positions therebetween, so that reliability and stability of signal transmission is enhanced. In conjunction with the elastic arm 14, the contacting portion can be adaptively adjusted, which may ensure that the floating terminal and the plug terminal always maintain good contact state therebetween.

In the floating terminal, the contacting portion can freely float in a certain range by means of the elastic arm 14, to be adapted to tolerance variation in a fitting process in different application situations. Therefore, with the floating terminal, working reliability of the receptacle connector in various complex circumstances can be further promoted, to make the receptacle connector perform excellently in different application situations.

In some embodiments, an elastic force of the second sub-contact portion 132 is larger than an elastic force of the elastic arm 14; that is, a force which makes the second sub-contact portion 132 elastically deformed is larger than a force which makes the elastic arm 14 elastically deformed.

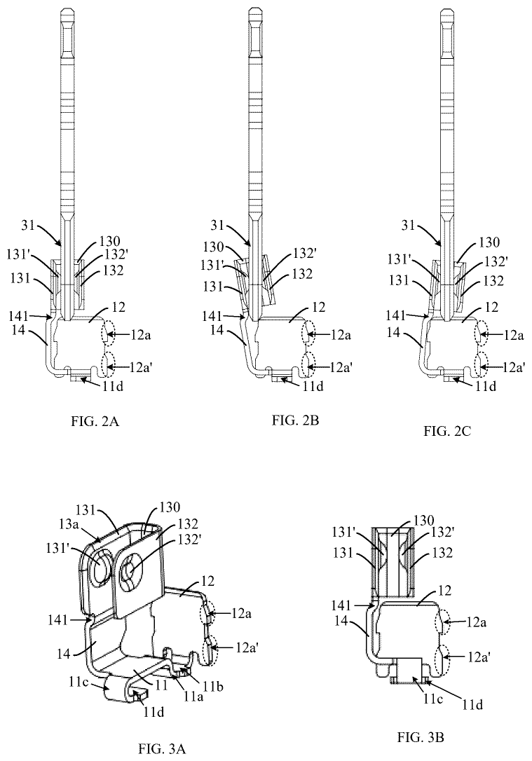

In conjunction with FIGS. 2A-2C, when the receptacle connector uses the floating terminal and mates with the plug connector, the plug terminal 31 of the plug connector mates with the floating terminal. With the floating terminal, with respect to a case that the plug terminal 31 is offset toward a side where the second sub-contact portion 132 is present (that is, a side of the contact portion which is not connected with the elastic arm 14), when the floating terminal is subjected to an external force, firstly the elastic arm 14 can be elastically deformed to absorb the external force under offsetting, so that the plug terminal 31 still can maintain good electrical connection with the first sub-contact portion 131 and the second sub-contact portion 132 at the same time. Therefore, the floating terminal is helpful to guarantee contact reliability of the receptacle connector.

FIGS. 2A-2C illustrates schematic views that the plug terminal 31 and the floating terminal and with each other, where FIG. 2A illustrates that there is not offset between the plug terminal 31 and the floating terminal, FIG. 2B illustrates that the plug terminal 31 is offset toward a side which is connected with the elastic arm 14, and FIG. 2C illustrates that the plug terminal 31 is offset toward a side which is connected with the elastic arm 14 . . . . It may be seen that, the present embodiment may ensure that the plug terminal 31 maintains good electrical connection with the first sub-contact portion 131 and the second sub-contact portion 132 at the same time in the case that the plug terminal 31 is offset toward the left or in a case that the plug terminal 31 is offset toward the right, which effectively guarantees contact stability of the receptacle connector.

As an example, the elastic force of the elastic arm 14 may be adaptively set by adjusting a width, a thickness and/or a length and the like of the elastic arm 14. The elastic force of the second sub-contact portion 132 also may be adaptively set by adjusting a width, a thickness and/or a length and the like of the second sub-contact portion 132. For example, the width of the second sub-contact portion 132 is larger than a width of the elastic arm 14; or, the length of the second sub-contact portion 132 is less than the length of the elastic arm 14.

Referring to FIGS. 1A-1E, in some embodiments, the elastic arm 14 is connected with the first sub-contact portion 131 via a bending portion 141. Specifically, an end of the bending portion 141 which is connected with the first sub-contact portion 131 bends toward the second sub-contact portion 132 relative to an end of the bending portion 141 which is connected with the elastic arm 14.

Generally on a basis of cost consideration, only the contacting portion is plated with gold, for example, the contacting portion includes the first sub-contact portion 131 and the second sub-contact portion 132, or, if the first contact point 131′ and the second contact point 132′ are provided, only the two contact points are plated with the gold. A contact pressure, which realizes electrical connection, of a region which is not plated with the gold is larger than a contact pressure, which realizes electrical connection, of a region which is plated with the gold. If the plug terminal is offset and then contacts the elastic arm 14 but does not contact the contacting portion which is plated with the gold, a contact pressure between the plug terminal and the elastic arm 14 may not satisfy a contact pressure which is required by electrical connection therebetween, which thus may affect electrical connection between the floating terminal and the plug terminal. In the floating terminal, the bending portion 141 at an upper end of the elastic arm 14 may provide an avoiding space when the plug terminal is offset toward a side where the second sub-contact portion 132 is present, to avoid that the plug terminal collides with the elastic arm 14 and in turn make the plug terminal separated from the first sub-contact portion 131, reliability of electrical connection between the floating terminal and the plug terminal is promoted. It is noted that the bending portion 141 is not necessarily an essential feature, and other manners also may be used to assure that the plug terminal and the floating terminal have reliable electrical connection therebetween.

In some embodiments, at least one side of the base portion 11 is provided with a bending segment, the bending segment bends downwardly toward a direction which is away from the contacting portion. With an elastic force which is provided by the bending segment for the contacting portion and is the same as an extending direction (for example, a vertical direction) of the elastic arm 14, the contacting portion is further capable of floating and displacing in the extending direction (for example, the vertical direction) of the elastic arm 14.

For convenient description, hereinafter a side of the base portion 11 which is opposite to the first side is defined as a third side.

In some embodiments, at least one side of the first side and the third side of the base portion 11 is sequentially provided with a bending segment and a horizontal segment.

As an example, as shown in FIGS. 1A-1E, the first side of the base portion 11 is sequentially provided with a first bending segment 11a and a first horizontal segment 11b, the fixing portion 12 is connected to a side of the first horizontal segment 11b which is away from first bending segment 11a, so as to be connected to the first side of the base portion 11.

Referring to FIGS. 1A-1E, in some embodiments, the third side of the base portion 11 is sequentially provided with a second bending segment 11c and a second horizontal segment 11d, the second bending segment 11c bends downwardly.

In the above embodiments, the first side of the base portion 11 is provided with the first bending segment 11a, and the opposite third side is provided with the second bending segment 11c. By provision of the first bending segment 11a and the second bending segment 11c, a phenomenon that a solder climbs or spreads along a soldering surface of the base portion 11 may be reduced, quality and reliability of soldering is ensured. At the same time, the first bending segment 11a and the second bending segment 11c may further provide a floating space in a height direction for the elastic arm 14, which makes that the contacting portion not only is capable of generating floating and displacing in the left-right direction but also is capable of generating floating and displacing in the height direction.

As an example, as shown in FIGS. 1A-1E, the first horizontal segment 11b and the second horizontal segment 11d may be located in the same plane.

Exemplarily, the horizontal segment provided to the third side of the base portion 11 may extend along a direction which is away from the first side of the base portion 11, also may extend along a direction which is toward the first side of the base portion 11.

FIGS. 1A-1E illustrate the first embodiment of the floating terminal, in the present embodiment, the horizontal segment provided to the third side of the base portion 11 (the second horizontal segment 11d) extends along a direction which is away from the first side of the base portion 11. As such, the base portion 11 between the first horizontal segment 11b and the second horizontal segment 11d and an external element have a gap therebetween, when the first horizontal segment 11b and the second horizontal segment 11d are soldered to the external element, solder wicking can be avoided, so that quality and reliability of soldering is promoted.

Exemplarily, the fixing portion 12 may be connected to the first horizontal segment 11b of the base portion 11 via a connecting segment 11a′.

Referring to FIGS. 3A-3B, a second embodiment of the floating terminal is illustrated. In the present embodiment, the horizontal segment provided to the third side of the base portion 11 (the second horizontal segment 11d) extends along a direction which is toward the first side of the base portion 11. As such, the horizontal segment does not expand outwardly to occupy an additional space, but effectively uses a space at a bottom of the base portion 11, so that an entire structure of the floating terminal is more compact, a space required to mount the floating terminal is reduced.

As shown in FIGS. 3A-3B, the first horizontal segment 11b and the second horizontal segment 11d also may be located in the same plane.

For convenient description, hereinafter a side of the base portion 11 which is opposite to the second side is defined as a fourth side.

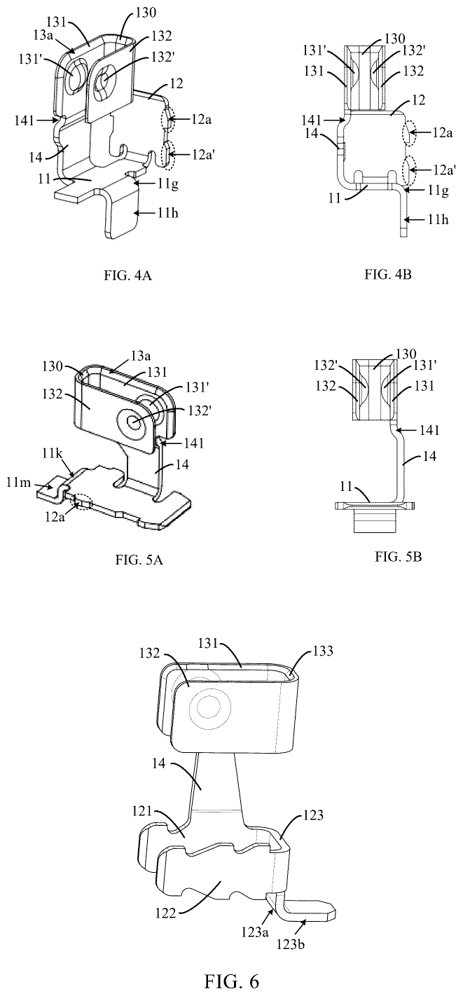

Referring to FIGS. 4A-4B, a third embodiment of the floating terminal is illustrated. In the present embodiment, the fourth side of the base portion 11 is sequentially provided with a bending segment and a vertical segment 11h.

Wherein, the bending segment is, for example, a third bending segment 11g as shown in FIGS. 4A-4B, bends downwardly from the fourth side of the base portion 11, and is connected to an end portion of the vertical segment 11h which extends downwardly.

In other embodiments, the third side of the base portion 11 may be sequentially provided with a bending segment and a vertical segment 11h, wherein, the bending segment may bend downwardly from the third side of the base portion 11, and be connected to an end portion of the vertical segment 11h which extends downwardly.

Continuously referring to FIGS. 1A-1E, 2A-2C, 3A-3B and 4A-4B, in some embodiments, two sides of the fixing portion 12 may be provided with at least one pair of protruding portions 12a, respectively. The protruding portion 12a extends outwardly from a side wall of the fixing portion 12, and can increase a width of the fixing portion 12. When the floating terminal is mounted in a receptacle housing, the protruding portion 12a may correspondingly snap into a terminal fixing groove of the receptacle housing, the protruding portion 12a may interference fit with groove walls of the terminal fixing groove, so that the fixing portion 12 is snapped and fixed in the terminal fixing groove, the floating terminal is fixed to the receptacle housing.

As shown in FIGS. 1A-1E, the two sides of the fixing portion 12 may be provided with one pair of protruding portions 12a and one pair of protruding portions 12a′, the pair of protruding portions 12a and the pair of protruding portions 12a′ may be provided to be spaced apart from each other up and down. Exemplarily, the protruding portions 12a′ provided below and the protruding portions 12a provided above may have different shapes, for example, the protruding portions 12a′ provided below may be larger than the protruding portions 12a provided above in a length in the vertical direction.

An embodiment of the present disclosure does not specifically limit the number and the shape of the protruding portion 12a, as long as the floating terminal can be fixed in the receptacle housing. In some embodiments, as shown in FIG. 1A to FIG. 4B, the two sides of the fixing portion 12 may be provided with two groups of the protruding portions 12a.

Continuously referring to FIG. 1A, in some embodiments, an edge of the contacting portion may be provided with a terminal guiding surface 13a. The terminal guiding surface 13a is connected to an inner wall of the contacting portion, and is oblique outwardly relative to the inner wall of the contacting portion. By provision of the terminal guiding surface 13a, it may facilitate inserting and pulling out of the plug terminal.

Specifically, the terminal guiding surface 13a may be provided at the opening of the contacting portion, for example, at a top of the first sub-contact portion 131, a top of the second sub-contact portion 132 and a top of the connecting portion 130, and an edge of the first sub-contact portion 131 and an edge of the second sub-contact portion 132 at the opening which faces the connecting portion 130 each may be provided with the terminal guiding surface 13a, the terminal guiding surface 13a has a shape which is oblique outwardly relative to an inner wall of any one of the first sub-contact portion 131, the second sub-contact portion 132 or the connecting portion 130.

It may be understood that the first embodiment and the second embodiment of the floating terminal illustrate the case that the first side and the third side of the base portion 11 each are sequentially provided with a bending segment and a horizontal segment. Next, referring to FIGS. 5A and 5B, an embodiment of the present disclosure further provides a floating terminal. The floating terminal specifically may include a base portion 11, a contacting portion and an elastic arm 14.

A first side of the base portion 11 is provided with a bending segment and a horizontal segment. For example, as shown in FIGS. 5A and 5B, the first side of the base portion 11 may be a side of the base portion 11 which is close to the connecting portion 130, and the first side of the base portion 11 may be provided with a fourth bending segment 11k and a third horizontal segment 11m.

The contacting portion specifically may include a first sub-contact portion 131 and a second sub-contact portion 132 which are spaced apart from and face each other, the first sub-contact portion 131 and the second sub-contact portion 132 may be connected to each other via a connecting portion 130.

The elastic arm 14 may bend from at least a part of a second side of the base portion 11 toward a direction which is close to the contacting portion and then be connected to the first sub-contact portion 131; wherein, the second side of the base portion 11 is adjacent to the first side.

The floating terminal also may make that the contacting portion is capable of freely floating in a certain range by means of the elastic arm 14, to be adapted to tolerance variation in a fitting process in different application situations. A specific working principle that the floating terminal makes the contacting portion freely float by means of the elastic arm 14 is similar to that of the floating terminal provided by the aforementioned embodiments, so the specific working principle of the elastic arm 14 may be referred to the description of the elastic arm 14 as above, here is not repeatedly described. Similarly, a structure of the floating terminal of the present embodiment which is the same as that of the floating terminal provided by the other embodiments is not repeatedly described here.

In some embodiments, as shown in FIGS. 5A and 5B, two sides of the base portion 11 are provided with at least one pair of protruding portions 12a, the two protruding portions 12a in the one pair of protruding portions 12a are respectively provided to the second side and a third side of the base portion 11; wherein, the third side and the second side of the base portion 11 are opposite to each other.

It is noted that an embodiment of the present disclosure does not specifically limit the manner that electrical connection between any one of the aforementioned floating terminals and an external element is realized, a structure which connects the floating terminal and the external element may be adaptively adjusted according to practical application requirement. As an example, it may employ but may not be limited to Surface-Mount Technology (SMT) or Dual In-line Package (DIP) technology to realize electrical connection between the floating terminal and the external element.

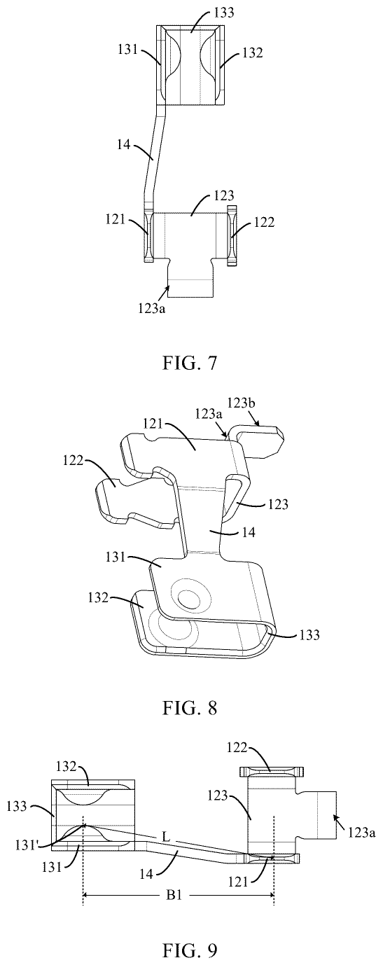

An embodiment of the present disclosure further provides another floating terminal. Referring to FIG. 6 to FIG. 10, a fifth embodiment of the floating terminal is illustrated. In the present embodiment, the floating terminal specifically may include a contacting portion, a fixing portion and an elastic arm 14.

As shown in FIG. 6 to FIG. 10, the contacting portion specifically may include a first sub-contact portion 131 and a second sub-contact portion 132 which are spaced apart from each other and face each other, the first sub-contact portion 131 and the second sub-contact portion 132 are connected to each other via a first connecting portion 133.

It is noted that the floating terminal mainly differs from the aforementioned floating terminals in that: the design of the fixing portion is different. As shown in FIG. 6 to FIG. 10, in the floating terminal, the fixing portion specifically may include a first sub-fixing portion 121 and a second sub-fixing portion 122 which are spaced apart from each other and face each other, the second sub-fixing portion 122 and the first sub-fixing portion 121 are connected to each other via a second connecting portion 123.

As shown in FIG. 6 to FIG. 10, the elastic arm 14 extends obliquely from the first sub-contact portion 131 toward a direction which is close to the fixing portion, and then is connected to the first sub-fixing portion 121.

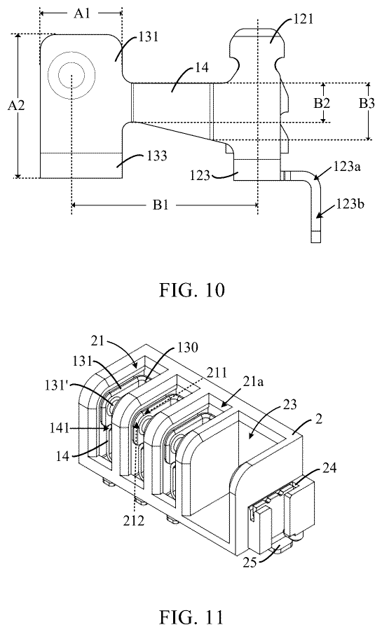

The floating terminal also may make that the contacting portion is capable of freely floating in a certain range by means of the elastic arm 14, to be adapted to tolerance variation in a fitting process in different application situations. Moreover, in conjunction with FIG. 9 and FIG. 10, the floating terminal lengthens an elastic length L of the elastic arm 14 with provision of the first sub-fixing portion 121, the elastic length L refers to a straight line distance between a center of a first contact point 131′ of the first sub-contact portion 131 and a center of the first sub-fixing portion 121, that is, a length of a line segment L of FIG. 9. Therefore, in a precondition that an entire dimension of the floating terminal is not increased, an elastic force of the elastic arm 14 is reduced, which makes the floating terminal more adapted to small space application situations. Lengthening the elastic length L of the elastic arm 14 is helpful to ensure that the floating terminal still can realize reliable electrical contact in a narrow and small space, so that connecting reliability and fitting fault tolerance of the floating terminal in small space application situations is promoted.

Continuously referring to FIG. 6 to FIG. 10, in some embodiments, the first sub-contact portion 131 and the first sub-fixing portion 121 are parallel to each other, and the second sub-contact portion 132 and the second sub-fixing portion 122 are parallel to each other.

Continuously in conjunction with FIG. 9 and FIG. 10, in some embodiments, the elastic length L of the elastic arm 14 is larger than a width B3 of a connected location between the elastic arm 14 and the first sub-fixing portion 121.

Continuously in conjunction with FIG. 10, in some embodiments, a width B2 of a connected location between the elastic arm 14 and the first sub-contact portion 131 is less than the width B3 of the connected location between the elastic arm 14 and the first sub-fixing portion 121.

And, in conjunction with FIG. 6 to FIG. 10, a dimension of the sub-contact portion (for example, the second sub-contact portion 132) decides the contact force of the floating terminal, a reasonable design of the dimension of the sub-contact portion can ensure that an enough contact force is generated when the floating terminal and the plug terminal mate with each other, to maintain good electrical connection. At the same time, a shape and a dimension of the elastic arm 14 decide the elastic force of the elastic arm 14.

In some embodiments, an elastic force of the sub-contact portion (for example, the second sub-contact portion 132) is larger than the elastic force of the elastic arm 14; that is, a force that makes the sub-contact portion elastically deformed (that is, the contact force) is larger than a force that makes the elastic arm 14 elastically deformed, so that, when the floating terminal is subjected to an external force, the plug terminal still can maintain tightly contact with the first sub-contact portion 131 and the second sub-contact portion 132 at the same time, which is helpful to guarantee contact reliability of the receptacle connector.

In the above embodiments, by adjusting a length (A1 as shown in FIG. 10), a thickness (not shown) and/or a width (A2 as shown in FIG. 10) of the sub-contact portion (the second sub-contact portion 132) and the width (B2 and B3 as shown in FIG. 10), a thickness (not shown) and/or length (B1 as shown in FIG. 10) of the elastic arm 14, it may ensure that, the contact force generated by the sub-contact portion is always larger than the elastic force generated by the elastic arm 14 under various working conditions, so that it assures that the two sub-contact portions can maintain reliable electrical contact with the plug terminal.

As an example, a side of the second connecting portion 123 away from the contacting portion is provided with a bending segment (for example, a fifth bending segment 123a as shown in FIG. 6 to FIG. 10) and a flat straight segment 123b which are sequentially connected, which will be specifically further described later in conjunction with specific embodiments of the receptacle connector.

According to some embodiments, another aspect of the present disclosure further provides a receptacle connector. Firstly referring to FIG. 11 to FIG. 14, the receptacle connector includes the floating terminal provided by any one embodiment of at least the first embodiment to the fourth embodiment and a receptacle housing 2.

Wherein, the receptacle housing 2 is provided with at least one terminal receiving cavity 21 and at least one terminal fixing groove 22, the terminal receiving cavity 21 and the terminal fixing groove 22 correspond to each other in one-to-one.

Specifically, the terminal fixing groove 22 is used to fix the floating terminal, the terminal receiving cavity 21 is used to receive the contacting portion and the elastic arm 14 of the floating terminal in a manner that the contacting portion of the floating terminal is capable of floating in the terminal receiving cavity 21; the base portion 11 of the floating terminal is at least partially exposed from a bottom of the receptacle housing 2.

In the receptacle connector, the contacting portion of the floating terminal is received in the terminal receiving cavity 21 in a manner that the contacting portion of the floating terminal is capable of floating in the terminal receiving cavity 21; that is, the contacting portion may offset left and right in the terminal receiving cavity 21, so that an offset due to vibration, fitting error or other errors in a fitting process is effectively compensated, and stability of electrical connection between the floating terminal and the plug terminal is ensured.

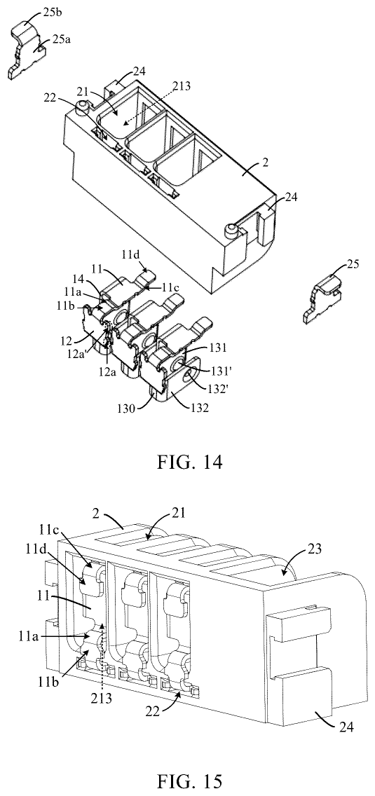

It is noted that, a specific position of the terminal fixing groove 22 may be adaptively set according to the shape and the structure of the floating terminal. For example, as shown in FIG. 14, the terminal fixing groove 22 may be provided to a rear surface of the receptacle housing 2.

As an example, in the receptacle connector as shown in FIG. 11 to FIG. 14, the receptacle housing 2 may be provided with the three terminal receiving cavities 21 and the three terminal fixing grooves 22, wherein each terminal receiving cavity 21 corresponds to one terminal fixing groove 22. The receptacle connector may provide the three floating terminals to be received in the three terminal receiving cavities 21 in one-to-one correspondence. The number of the floating terminal received in the receptacle connector is set according to practical cases, and is not imposed on limitation.

Optionally, when the receptacle connector has requirement on small dimension, a partitioning wall between the terminal receiving cavities may be set to have different thicknesses, for example, an upper side of the partitioning wall is thinner than a lower side of the partitioning wall to provide a floating space for the contacting portion, at the same time also assure that the receptacle housing has better strength, as shown in FIG. 19.

Exemplarily, as shown in FIG. 14, the bottom of the receptacle housing 2 may be provided with a soldering opening 213 which corresponds to the terminal receiving cavity 21 in one-to-one. When the floating terminal inserts into the receptacle housing 2, the base portion 11 of the floating terminal is positioned to the bottom of the terminal receiving cavity 21. The soldering opening 213 may expose the base portion 11 of the floating terminal to allow the base portion 11 of the floating terminal to be further soldered to an external element. For example, the external element may be a Printed Circuit Board (PCB). In other examples, a part of the base portion 11 may also be exposed by other forms, which will be specifically described later.

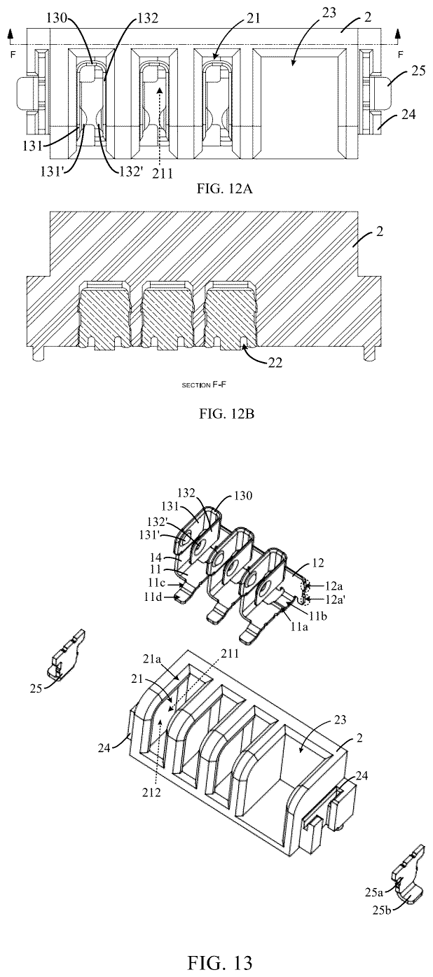

Referring to FIG. 11, FIG. 12A and FIG. 13, in some embodiments, a cavity opening of the terminal receiving cavity 21 may include a first opening 211 which is provided to a first surface of the receptacle housing 2 and a second opening 212 which is provided to a second surface of the receptacle housing 2. Wherein, the first surface and the second surface are adjacent to each other, and the first opening 211 and the second opening 212 are communicated with each other.

In the receptacle connector, by that the terminal receiving cavity 21 of the receptacle housing 2 is provided with the openings (the first opening 211 and the second opening 212) which are respectively positioned at two sides of the terminal receiving cavity 21 and are communicated with each other, multi-angle inserting and pulling out of the plug connector which mates with the receptacle connector may be satisfied. Convenience, compatibility and adaptability of operating the receptacle connector are promoted.

Such multi-angle inserting and pulling out design increases flexibility of the receptacle connector, a user is no longer limited to a single direction in inserting and pulling out of the plug connector. Therefore, the receptacle connector can be adapted to application situations where a space is limited.

Continuously referring to FIG. 11, in some embodiments, the cavity opening of the terminal receiving cavity 21 may be provided with a housing guide surface 21a. The housing guide surface 21a is connected to an inner wall of the terminal receiving cavity 21, and is oblique outwardly relative to the inner wall of the terminal receiving cavity 21. The housing guide surface 21a may facilitate inserting and pulling out of the plug terminal.

As an example, the terminal receiving cavity 21 and the contacting portion of the floating terminal may have a gap therebetween, so that the contacting portion of the floating terminal has floating space. The floating space may be adaptively set according to a dimension of the contacting portion of the floating terminal and floating requirement, the present disclosure does not have limitation thereto.

Continuously referring to FIG. 11 to FIG. 14, in some embodiments, the receptacle housing 2 may be further provided with at least one foolproof receiving cavity 23. The foolproof receiving cavity 23 is provided alongside one terminal receiving cavity 21.

Exemplarily, the foolproof receiving cavity 23 and the terminal fixing groove 22 are respectively positioned to two different sides of the terminal receiving cavity 21. For example, as shown in FIG. 13, the foolproof receiving cavity 23 is provided to a right side of the terminal receiving cavity 21, the terminal fixing groove 22 is positioned to a rear surface of the receptacle housing 2, that is, a rear side of the terminal receiving cavity 21.

An embodiment of the present disclosure does not specifically limit the dimension of the foolproof receiving cavity 23. The dimension of the foolproof receiving cavity 23 may be adaptively set according to a dimension of a foolproof structure.

Continuously referring to FIG. 11 to FIG. 14, in some embodiments, the receptacle housing 2 may be further provided with at least one pair of fixing piece insertion grooves 24. The two fixing piece insertion grooves 24 in each pair of fixing piece insertion grooves 24 may be provided respectively to two opposite sides of the receptacle housing 2.

As shown in FIG. 11 to FIG. 14, the receptacle connector may further include at least one pair of fixing pieces 25. The fixing pieces 25 and the fixing piece insertion grooves 24 are provided in one-to-one correspondence, and the fixing piece 25 inserts into the corresponding fixing piece insertion groove 24. The fixing piece 25 may be used to connect with an external element, for example, the fixing piece 25 is soldered to the external element, to realize fixing and mounting of the receptacle connector with the external element, the fixing piece 25 can provide good fixing effect. Wherein, for example, the external element may be a PCB.

Exemplarily, as shown in FIG. 13 and FIG. 14, the fixing piece 25 may include a first part 25a and a second part 25b which are perpendicular to each other and are connected to each other; wherein, the first part 25a of the fixing piece 25 may be used to insert into the fixing piece insertion groove 24, the second part 25b may be used to be soldered to the external element (for example, the PCB), to realize connection with the external element.

It is noted that, the floating terminals provided by the aforementioned embodiments may be applied to the corresponding receptacle connector, so technical features between the embodiments of the floating terminal and the embodiments of the receptacle connector may be mutually substituted and replenished with a precondition that confliction is not generated, so that a person skilled in the art can get to know technical content of the present disclosure.

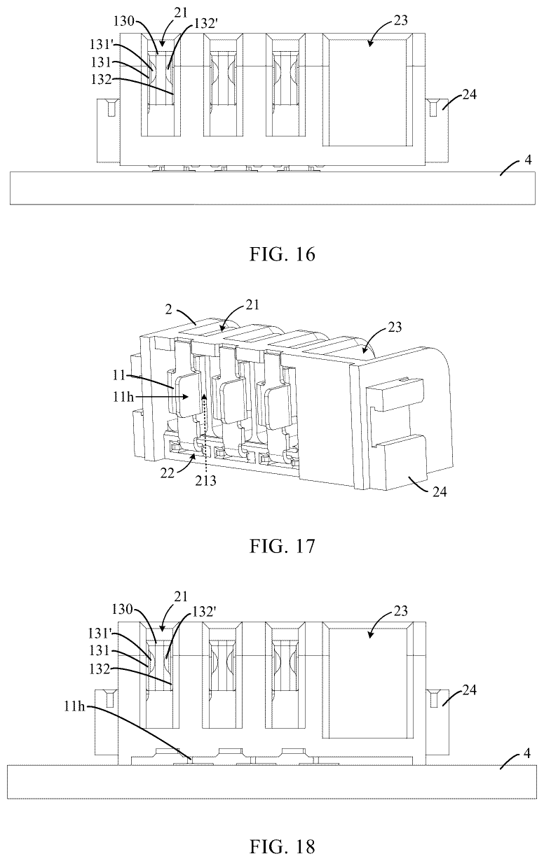

For example, FIG. 15 and FIG. 16 respectively are a perspective view and a front view illustrating that the floating terminal as shown in FIGS. 3A and 3B is mounted to the receptacle housing 2.

In the present embodiment, the bending segments (the first bending segment 11a and the second bending segment 11c) of the base portion 11 are received in the terminal receiving cavity 21. The soldering opening 213 exposes at least a part of the base portion 11 of each floating terminal, at this time, the horizontal segments (the first horizontal segment 11b and the second horizontal segment 11d) of the base portion 11 are positioned to the bottom of the receptacle housing 2, and may be allowed to be further soldered to the external element (for example, a PCB 4).

For example, FIG. 17 and FIG. 18 respectively are a perspective view and a front view illustrating that the floating terminal as shown in FIGS. 4A and 4B is mounted to the receptacle housing 2.

In the present embodiment, the bending segment of the base portion 11 is received in the terminal receiving cavity 21. The soldering opening 213 exposes the base portion 11 of each floating terminal, at this time, the vertical segment 11h of the base portion 11 extends out of a bottom surface of the receptacle housing 2 to be allowed to be further soldered to the external element (for example, the PCB).

Referring to FIG. 19 to FIG. 24B, in some embodiments, the receptacle connector may include the floating terminal as shown in FIGS. 5A-5B and a receptacle housing 2.

In the present embodiment, the terminal fixing groove 22 is provided corresponding to at least one pair of protruding portions 12a which are provided to the two sides of the base portion 11 of the floating terminal. As shown in FIG. 19, the terminal fixing groove 22 is provided to the bottom of the receptacle housing 2. When the floating terminal for example as shown in FIGS. 5A-5B is mounted to the receptacle housing 2, the protruding portions 12a of the floating terminal may insert into the terminal fixing groove 22 which is provided to the bottom of the receptacle housing 2, to realize fixing of the floating terminal.

Optionally, an upper surface of the terminal fixing groove 22 which is positioned below the corresponding elastic arm 14 of the floating terminal is partially recessed downwardly to form a recessed portion 22′ to avoid the elastic arm 14, which provides a longer effective elastic length to the elastic arm 14. In the present embodiment, the soldering opening 213 is provided to the rear surface of the receptacle housing 2 and is positioned to the bottom of the receptacle housing 2, and may expose the bending segment (the fourth bending segment 11k) and the horizontal segment (the third horizontal segment 11m) of the base portion 11 of each floating terminal. The horizontal segment (the third horizontal segment 11m) which is exposed may be used to be further soldered to the external element (for example, the PCB).

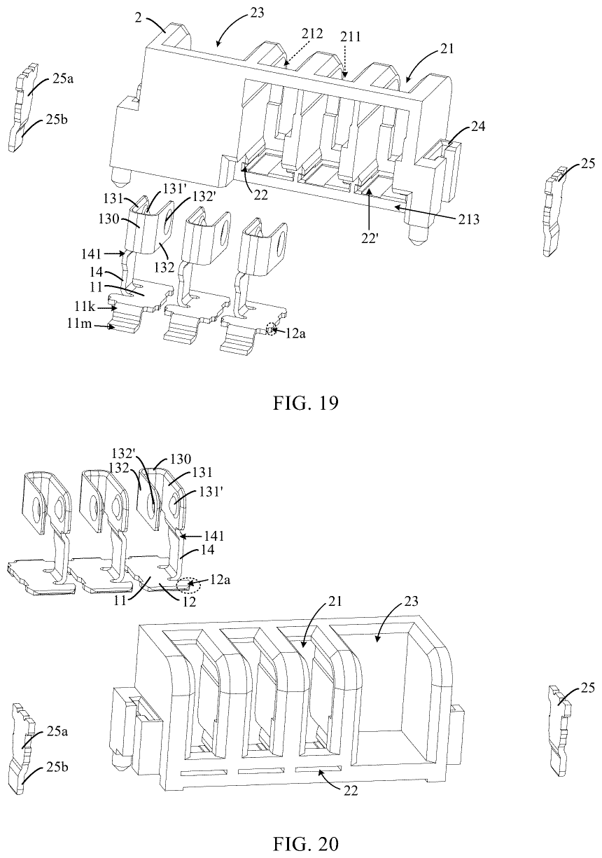

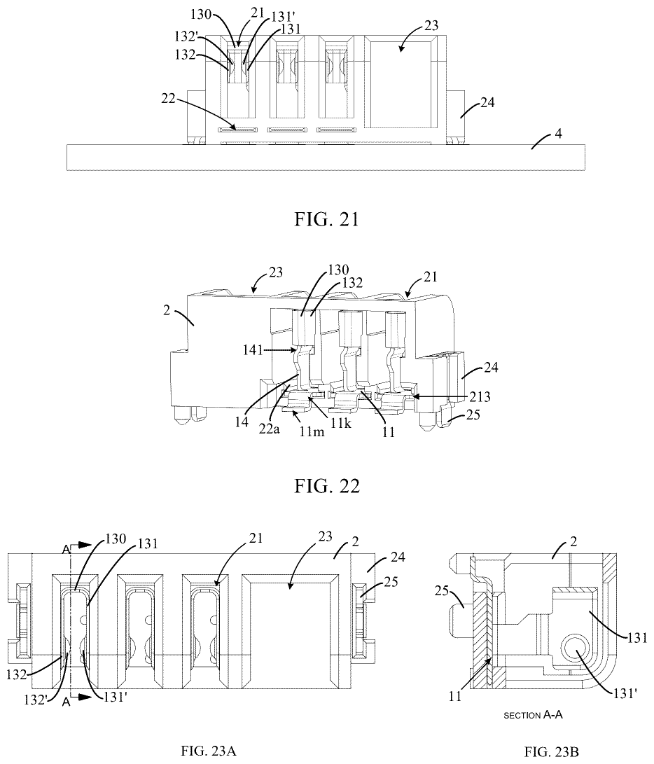

Continuously referring to FIG. 19 and FIG. 20, in some embodiments, the fixing piece 25 may include a first part 25a and a second part 25b which are connected to each other, and an extending direction of the first part 25a and an extending direction of the second part 25b are the same or are substantially the same. Wherein, the first part 25a of the fixing piece 25 may be used to insert into the fixing piece insertion groove 24, the second part 25b may insert into a mounting hole of the external element (for example, the PCB), to realize mechanical connection with the external element.

It is noted that an embodiment of the present disclosure does not specifically limit the manner that mechanical connection between the fixing piece 25 and the external element is realized, a structure which connects the fixing piece 25 and the external element may be adaptively adjusted according to practical application requirements. As an example, it may employ but may not be limited to SMT manner or DIP manner to realize mechanical connection between the fixing piece 25 and the external element.

In conjunction with FIG. 11 to FIG. 24B, an embodiment of the present disclosure does not specifically limit a direction where the elastic arm 14 is located when the floating terminal inserts into the receptacle connector. The elastic arm 14 may be either positioned to a side which is close to the left in the terminal receiving cavity 21, or may be positioned to a side which is close to the right in the terminal receiving cavity 21, both are permitted.

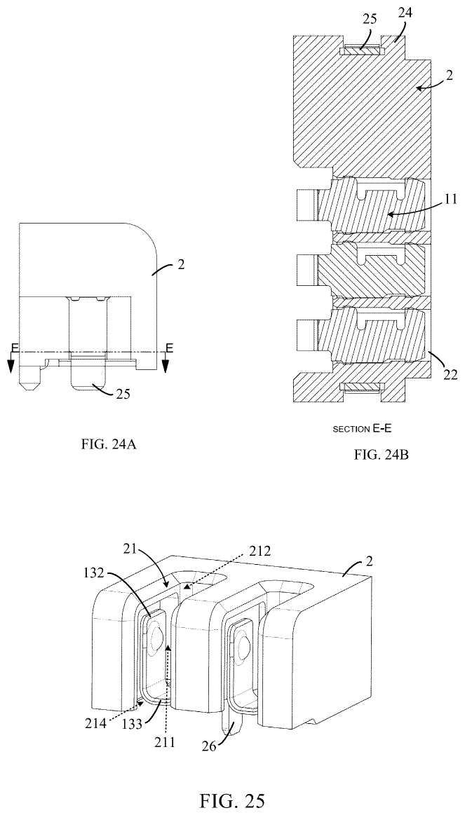

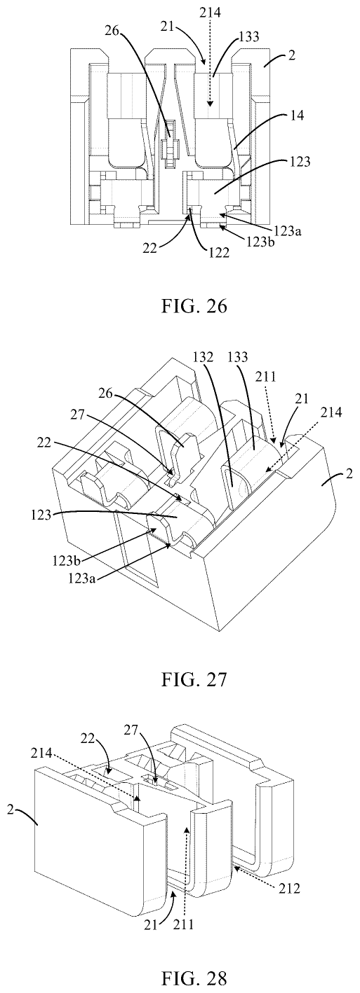

According to some embodiments, the present disclosure further provides another receptacle connector. Referring to FIG. 25 to FIG. 27, the receptacle connector includes at least one floating terminal provided by the fifth embodiment and a receptacle housing 2.

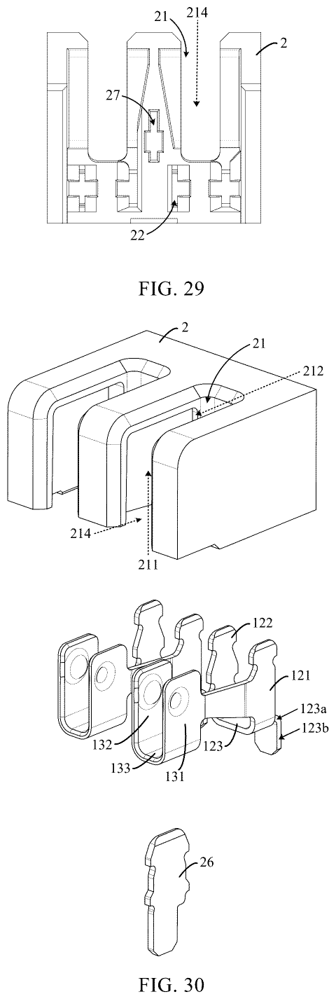

It is noted that, the receptacle connector mainly differs from the aforementioned receptacle connector in that: as shown in FIG. 28 and FIG. 29, the receptacle housing 2 is provided with at least one terminal receiving cavity 21 and at least one pair of terminal fixing grooves 22, each terminal receiving cavity 21 corresponds to one pair of terminal fixing grooves 22.

Wherein, the terminal receiving cavity 21 is used to receive the contacting portion and the elastic arm 14 of the floating terminal in a manner that the contacting portion of the floating terminal is capable of floating in the terminal receiving cavity 21, the terminal fixing grooves 22 are used to fix the floating terminal provided by the fifth embodiment, the two terminal fixing grooves 22 in each pair of terminal fixing grooves 22 respectively correspond to the first sub-fixing portion 121 and the second sub-fixing portion 122 of the floating terminal. The terminal fixing groove 22, which corresponds to the first sub-fixing portion 121 is communicated with the terminal receiving cavity 21, to allow the elastic arm 14 to extend from the first sub-fixing portion 121 to the terminal receiving cavity 21.

Referring to FIG. 27, in the above embodiment, by that the first sub-fixing portion 121 and the second sub-fixing portion 122 are inserted into the corresponding terminal fixing grooves 22, fixing and mounting of the floating terminal with the receptacle housing 2 may be realized. It is noted that, a retention force to the first sub-fixing portion 121 is less than a retention force to the second sub-fixing portion 122, so the first sub-fixing portion 121 may have a certain slightly floating, and the elastic length L of the elastic arm 14 may be lengthened in a certain extent.

Continuously referring to FIG. 25 to FIG. 27, in some embodiments, a cavity opening of the terminal receiving cavity 21 includes a first opening 211 which is provided to a first surface of the receptacle housing 2, a second opening 212 which is provided to a second surface of the receptacle housing 2, and a third opening 214 which is provided to a third surface of the receptacle housing 2; the third surface, the first surface and the second surface are sequentially connected with each other, and the third opening 214, the first opening 211 and the second opening 212 are sequentially communicated with each other.

As an example, a side of the second connecting portion 123 away from the contacting portion is provided with a bending segment (for example, the fifth bending segment 123a as shown in FIG. 6 to FIG. 10) and a flat straight segment 123b which are sequentially connected.

Wherein, the fifth bending segment 123a bends outwardly toward a direction which is away from the fixing portion, and the fifth bending segment 123a of the second connecting portion 123 is at least partially exposed from the bottom of the receptacle housing 2. At this time, the flat straight segment 123b may extend out of the third opening 214 at the third surface of the receptacle housing 2, as shown in FIG. 27, to be allowed to be further soldered to an external element (for example, a PCB).

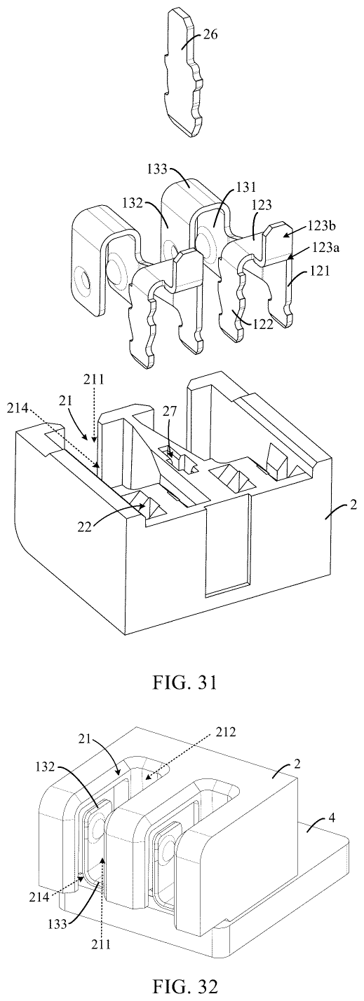

Referring to FIG. 30 and FIG. 31, the receptacle connector may further include at least one fitting member 26. In conjunction with FIG. 28, in some embodiments, the receptacle housing 2 may be further provided with at least one fitting member insertion groove 27.

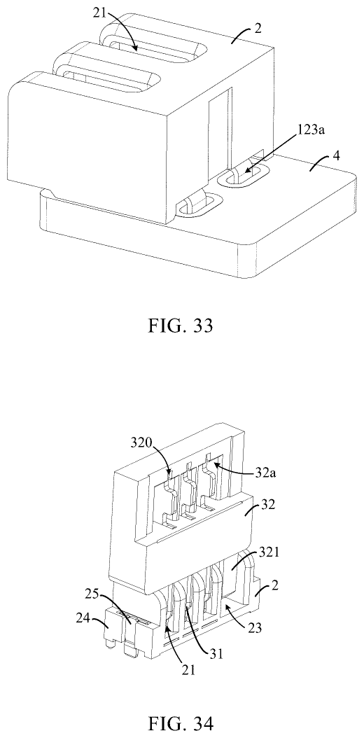

In the receptacle connector, the fitting member 26 and the fitting member insertion groove 27 are provided in one-to-one correspondence. As shown in FIG. 27, the fitting member 26 at least partially inserts into the corresponding fitting member insertion groove 27. The fitting member 26 may be used to be connected with the external element, for example, a part of the fitting member 26 which extends out of the fitting member insertion groove 27 is fixed with the external element, to realize fixing and mounting of the receptacle connector with the external element, the fitting member 26 can provide good fixing effect. Wherein, as shown in FIG. 32 and FIG. 33, the fitting member 26 may be soldered on the external element, for example, a PCB 4.

According to some embodiments, still another aspect of the present disclosure further provides a plug connector which is used to correspondingly mate with the receptacle connector provided by the aforementioned embodiments. Therefore, the technical effects which can be realized by the aforementioned receptacle connector also can be realized here, and are not repeatedly described here.

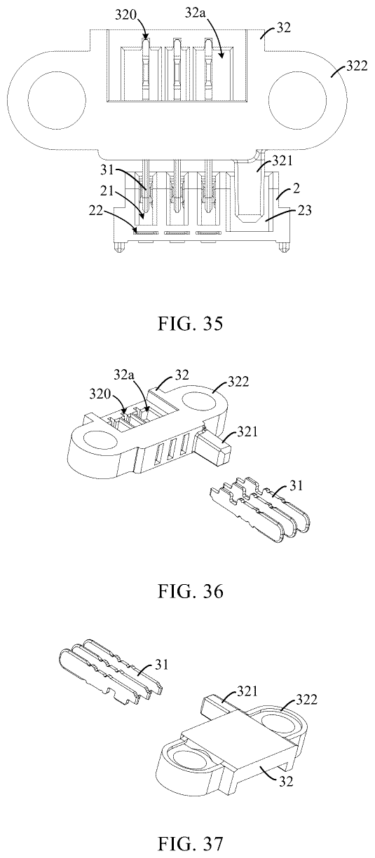

Referring to FIG. 34 to FIG. 35, in some embodiments, the plug connector includes at least one plug terminal 31. It is noted that, the plug terminal 31 also may be referred to as a “male terminal”. As shown in FIG. 34 and FIG. 35, the plug terminal 31 mates with the corresponding floating terminal of the receptacle connector, to realize electrical connection between the plug connector and the receptacle connector.

Specifically, referring to FIG. 35, when the plug terminal 31 mates with the corresponding floating terminal, two sides of the plug terminal 31 respectively contact and connect the first sub-contact portion 131 and the second sub-contact portion 132.

For example, in the plug connector as shown in FIG. 36 and FIG. 37, the plug connector is mounted with the three plug terminals 31. The plug connector may correspondingly mate with any one of the receptacle connectors as shown in FIG. 11 to FIG. 24B, when mating is completed, the three plug terminals 31 mate with the three floating terminals in one-to-one correspondence. Exemplarily, as shown in FIG. 34 and FIG. 35, the plug connector may correspondingly mate with the receptacle connector as shown in FIG. 19 to FIG. 24B.

An embodiment of the present disclosure does not specifically limit a form of the plug terminal 31. As an example, the plug terminal 31 may include a blade terminal. The blade terminal not only can satisfy high current application requirements, but also is simple in structure and is easily produced and fitted.

Referring to FIG. 36 to FIG. 37, in some embodiments, the plug connector may further include at least one plug housing 32. The plug housing 32 has a receiving space 32a which is used to receive the plug terminal 31.

In some embodiments, the plug housing 32 may be further provided with a terminal insertion groove 320. The terminal insertion groove 320 may be communicated with the receiving space 32a to allow an end portion of the plug terminal 31 to insert therein. As such, stabler fixing effect on the plug terminal 31 can be functioned.

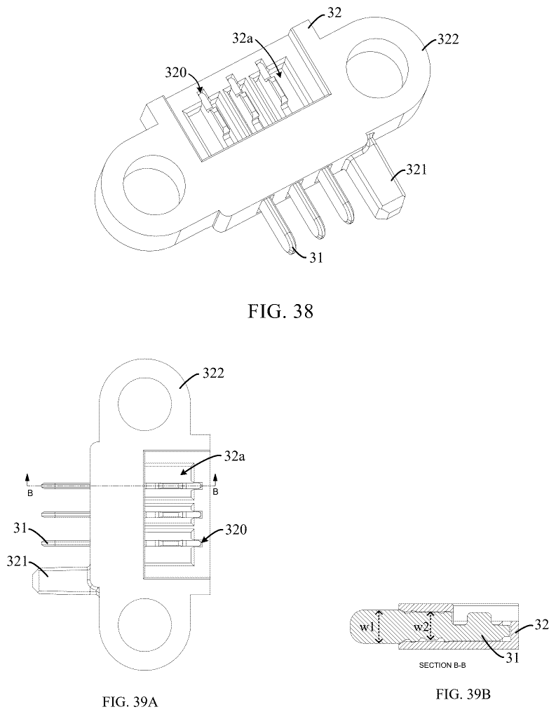

In conjunction with FIG. 38 and FIGS. 39A and 39B, the plug terminal 31 may include a mounting region and a contacting region; wherein, the mounting region inserts into the plug housing 32, the contacting region extends out of the plug housing 32.

For convenience explanation of following embodiments, it defines that the mounting region of the plug terminal 31 inserts into the plug housing 32 along a first direction, and it defines that a second direction is perpendicular to the first direction.

Referring to FIGS. 39A and 39B, in some embodiments, a width w1 of the contacting region of the plug terminal 31 in the second direction is larger than a width w2 of the mounting region in the second direction. As such, when there is a requirement for small dimensions of the plug connector in the second direction, such a design may increase an effective contacting length between the plug terminal 31 and the floating terminal in the second direction.

As an example, the plug connector may be electrically connected with a plug connecting element via the plug terminal 31. The plug terminal 31 may be electrically connected with the plug connecting element in DIP manner or SMT manner, but the present disclosure is not limited thereto, as long as electrical connection between the plug terminal 31 and the plug connecting element can be realized.

An embodiment of the present disclosure does not specifically limit a form of the plug connecting element. As an example, the plug connecting element may include a Flexible Printed Circuit (FPC) board; in other embodiments, the plug connecting element may also include a PCB and/or a cable.

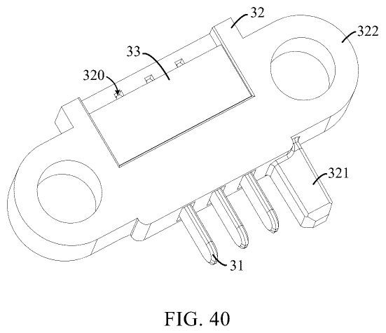

For example, when the plug terminal 31 is connected with the FPC, referring to FIG. 40, a connecting region may be covered by an adhesive layer 33, the adhesive layer 33 protects the connecting region, avoids the connecting region contacting other conductive region to result in short-circuit.

As an example, the adhesive layer 33 is not higher than a surface of the plug housing 32, to assure flatness of mounting of the plug connector.

In some embodiments, as shown in FIG. 34, the plug housing 32 may be provided with at least one foolproof structure 321. The foolproof structure 321 is configured so that: when the plug housing 32 sheathes the plug terminal 31, the foolproof structure 321 is positioned in the foolproof receiving cavity 23 of the receptacle housing 32.

When the plug connector mates with the receptacle connector, the foolproof structure 321 first inserts into the corresponding foolproof receiving cavity 23 of the receptacle connector, to prevent wrong operation (foolproof); at the same time, the foolproof structure 321 may further function to guide proper mounting and operating.

An embodiment of the present disclosure does not specifically limit a length of the foolproof structure 321. As an example, the length of the foolproof structure 321 may be larger than a length of the plug terminal 31, so that, when the plug connector mates with the receptacle connector, before the plug terminal 31 mates with the floating terminal, the foolproof structure 321 can firstly inserts into the foolproof receiving cavity 23 to ensure realize foolproof function.

In some embodiments, a width of the foolproof structure 321 may be set to be larger than a width of each terminal receiving cavity 21 so as to be beneficial to realize better foolproof function. As an example, a part of the foolproof structure 321 may extend forwardly from a front mating face of the plug terminal 31, a part of the foolproof structure 321 may extend forwardly from a side surface of the plug housing 32. As such, the foolproof structure 321 not only may satisfy dimension requirement, but also does not enlarge an entire size of the plug connector in the width direction.

As an example, each edge of the foolproof structure 321 may has a chamber to facilitate that the foolproof structure 321 is guided to insert into the foolproof receiving cavity 23.

In some embodiments, as shown in FIG. 35, the plug housing 32 may be further provided with at least one positioning structure 322. In the plug connector as shown in FIG. 35, two opposite sides of the plug housing 32 are respectively provided with positioning structures 322. The positioning structures 322 may be used to cooperate with an external element. It may be understood that the plug connector also may not be provided with the positioning structure 322, as shown in FIG. 34.

The various technical features of the above embodiments can be combined in any way. In order to make the description concise, not all possible combinations of the various technical features of the above embodiments have been described. However, as long as there is no contradiction in the combination of these technical features, they should be considered within the scope of this specification.

The above embodiments only express several embodiments of the present disclosure, and their descriptions are more specific and detailed, but should not be understood as limiting the scope of the patent disclosure. It should be pointed out that, for ordinary technical personnel in this field, several variations and modifications can be made without departing from the concept of the present disclosure, which are within the scope of protection of the present disclosure. Therefore, the scope of protection of the present disclosure should be based on the appended claims.

What is claimed is:

1. A floating terminal, comprising:
a base portion;
a fixing portion connected with a first side of the base portion;
a contacting portion comprising a first sub-contact portion and a second sub-contact portion, which are spaced apart from each other and face each other, the first sub-contact portion and the second sub-contact portion being connected via a connecting portion;
an elastic arm bending from at least a part of a second side of the base portion toward a direction which is close to the contacting portion and extending, and then being connected to the first sub-contact portion, the second side and the first side of the base portion being adjacent to each other.

2. The floating terminal according to claim 1, wherein
an elastic force of the second sub-contact portion is larger than an elastic force of the elastic arm.

3. The floating terminal according to claim 1, wherein
the elastic arm is connected to the first sub-contact portion via a bending portion,
an end of the bending portion which is connected to the first sub-contact portion bends toward the second sub-contact portion relative to an end of the bending portion which is connected to the elastic arm.

4. The floating terminal according to claim 1, wherein
at least one side of the base portion is provided with a bending segment, the bending segment bends downwardly toward a direction which is away from the contacting portion.

5. The floating terminal according to claim 4, wherein
the base portion further comprises a third side opposite to the first side,
at least one side of the first side and the third side of the base portion is sequentially provided with the bending segment and a horizontal segment.

6. The floating terminal according to claim 5, wherein
the first side of the base portion is sequentially provided with a first bending segment and a first horizontal segment;
the fixing portion is connected to a side of the first horizontal segment, which is away from the first bending segment, to be connected to the first side of the base portion;
the third side of the base portion is sequentially provided with a second bending segment and a second horizontal segment.

7. The floating terminal according to claim 5, wherein
the horizontal segment provided to the third side of the base portion extends along a direction which is away from the first side of the base portion, or extends along a direction which is toward the first side of the base portion.

8. The floating terminal according to claim 4, wherein
the base portion further comprises a fourth side opposite to the second side, the fourth side of the base portion is provided with the bending segment and a vertical segment.

9. The floating terminal according to claim 1, wherein
two sides of the fixing portion are provided with at least one pair of protruding portions.

10. A floating terminal, comprising:
a base portion having a first side which is provided with a bending segment and a horizontal segment;
a contacting portion comprising a first sub-contact portion and a second sub-contact portion which are spaced apart from each other and face each other, the first sub-contact portion and the second sub-contact portion being connected via a connecting portion;
an elastic arm bending from at least a part of a second side of the base portion toward a direction which is close to the contacting portion and extending, and then being connected to the first sub-contact portion, the second side and the first side of the base portion being adjacent to each other.

11. The floating terminal according to claim 10, wherein
two sides of the base portion are provided with at least one pair of protruding portions,
the two protruding portions in the pair of protruding portions are respectively provided to the second side and a third side of the base portion,
the third side of the base portion is opposite the second side.

12. A floating terminal, comprising:
a contacting portion comprising a first sub-contact portion and a second sub-contact portion which are spaced apart from each other and face each other, the first sub-contact portion and the second sub-contact portion being connected via a first connecting portion;
a fixing portion comprising a first sub-fixing portion and a second sub-fixing portion which are spaced apart from each other and face each other, the second sub-fixing portion and the first sub-fixing portion being connected via a second connecting portion;
an elastic arm extending obliquely from the first sub-contact portion toward a direction which is close to the fixing portion and then being connected to the first sub-fixing portion.

13. The floating terminal according to claim 12, wherein
the first sub-contact portion and the first sub-fixing portion are parallel to each other, and the second sub-contact portion and the second sub-fixing portion are parallel to each other.

14. The floating terminal according to claim 12, wherein
a width of a connected location between the elastic arm and the first sub-contact portion is less than a width of a connected location between the elastic arm and the first sub-fixing portion.

15. The floating terminal according to claim 14, wherein
a distance between the contacting portion and the fixing portion is larger than the width of the connected location between the elastic arm and the first sub-fixing portion.

16. A receptacle connector, comprising at least one floating terminal of claim 1, and a receptacle housing;
the receptacle housing being provided with at least one terminal receiving cavity and at least one terminal fixing groove, the terminal receiving cavity corresponding to the terminal fixing groove in one-to-one;
wherein, the terminal fixing groove is used to fix the floating terminal, the terminal receiving cavity is used to receive the contacting portion and the elastic arm of the floating terminal in a manner that the contacting portion of the floating terminal is capable of floating in the terminal receiving cavity, the base portion of the floating terminal is at least partially exposed from a bottom of the receptacle housing.

17. The receptacle connector according to claim 16, wherein
a cavity opening of the terminal receiving cavity comprises a first opening which is provided to a first surface of the receptacle housing and a second opening which is provided to a second surface of the receptacle housing,
the first surface and the second surface are adjacent to each other, and the first opening and the second opening are communicated with each other.

18. A receptacle connector, comprising at least one floating terminal of claim 12 and a receptacle housing,
the receptacle housing being provided with at least one terminal receiving cavity and at least one pair of terminal fixing grooves, each terminal receiving cavity corresponding to one pair of terminal fixing grooves;
wherein, the terminal fixing groove is used to fix the floating terminal, the terminal receiving cavity is used to receive the contacting portion and the elastic arm of the floating terminal in a manner that the contacting portion of the floating terminal is capable of floating in the terminal receiving cavity.

19. The receptacle connector according to claim 18, wherein
a cavity opening of the terminal receiving cavity comprises a first opening which is provided to a first surface of the receptacle housing, a second opening which is provided to a second surface of the receptacle housing, and a third opening which is provided to a third surface of the receptacle housing;
the third surface, the first surface and the second surface are sequentially connected to each other, and
the third opening, the first opening and the second opening are sequentially communicated to each other.

20. A plug connector, used to correspondingly mate with the receptacle connector of claim 16,
the plug connector comprising at least one plug terminal,
wherein, the plug terminal of the plug connector mates with the floating terminal of the corresponding receptacle connector, to realize electrical connection between the plug connector and the receptacle connector, wherein the plug connector further comprises at least one plug housing; and
the plug terminal comprises a mounting region and a contacting region, the mounting region inserts into the plug housing, the contacting region extends out of the plug housing.
